(19) United States
(12) Patent Application Publication
(10) Pub. No.: US 2013/0134907 A1
(43) Pub. Date: May 30, 2013

(54) LED GLASS AND METHOD FOR MANUFACTURING THE SAME

(71) Applicant: SUNG-HSIANG YANG, Chu-Nan (TW)

(72) Inventor: SUNG-HSIANG YANG, Chu-Nan (TW)

(73) Assignee: FOXSEMICON INTEGRATED TECHNOLOGY, INC., Miao-Li Hsien (TW)

(21) Appl. No.: 13/330,690

(22) Filed: Dec. 20, 2011

(30) Foreign Application Priority Data
Nov. 28, 2011 (TW) 100143516

(51) Int. Cl. H05B 37/02; H01J 9/24; F21V 3/00

(52) U.S. Cl. 315/363; 362/311.02; 445/23

(57) ABSTRACT

An LED (light emitting diode) glass includes a glass base, a plurality of LEDs mounted on the base, an interlayer disposed on the base and a glass cover disposed on the interlayer. The interlayer defines an opening to receive the LEDs. An outer periphery of the interlayer and two facing faces of the base and the cover form a plurality of grooves in a periphery of the LED glass. An adhesive material is filled in each of the grooves to fix the cover, the interlayer and the base together. A method for manufacturing the LED glass is also provided.

### BACKGROUND

1. Technical Field

The present disclosure relates to LED (light emitting diode) devices and methods for manufacturing the LED devices, and more particularly, to an LED glass and a method for manufacturing the LED glass.

2. Description of Related Art

As new type of light source, LEDs are widely used in various applications, such as road lamps, traffic lamps, tunnel lamps, resident lamps and so on. A new LED product called LED glass appears in recent years. The LED glass has a special light effect compared with the other typical LED devices, and becomes popular in many occasions. The LED glass generally includes a glass base, a glass cover and a plurality of LEDs mounted between the base and the cover. During assembly of the LED glass, a transparent interlayer, often made of PVB (polyvinyl butyral), is disposed between the base and the cover and covers the LEDs, and then heated together with the cover and the base under a temperature about 150-200 degrees Celsius. The interlayer thus melts and glues the cover and the base together.

However, the refractive index of the interlayer made of PVB changes during heating. The light emitted by the LEDs, after passing through the part of cover just above the LEDs, would be refracted by the interlayer to form a plurality of halos. The halos affect the normal light emission of the LED glass and are thus undesirable.

What is needed, therefore, is an LED glass and a method for manufacturing the LED glass which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an LED glass in accordance with an embodiment of the present disclosure.

FIG. 2 is an inverted view of the LED glass of FIG. 1.

FIG. 3 is an exploded view of the LED glass of FIG. 1.

FIG. 4 is an inverted view of the LED glass of FIG. 3.

FIG. 5 is a schematic view showing electrical routes of the LED glass of FIG. 1.

FIG. 6 is a cross sectional view of the LED glass of FIG. 1.

FIG. 7 is an enlarged view of circled part VII of the LED glass of FIG. 6, wherein an adhesive material is filled in the LED glass.

FIG. 8 is a top view of an interlayer of an LED glass in accordance with another embodiment of the present disclosure.

### DETAILED DESCRIPTION OF THE EMBODIMENTS

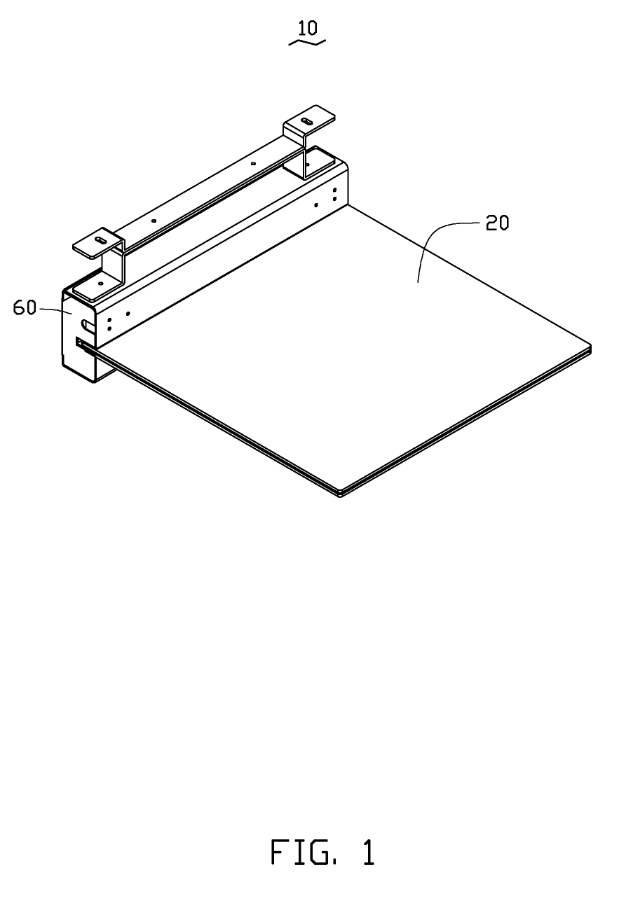

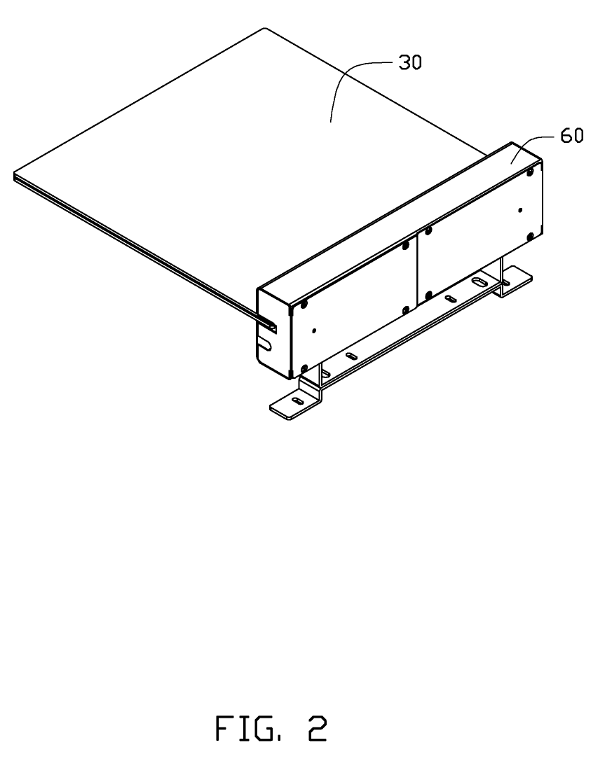

Referring to FIGS. 1-4, an LED (light emitting diode) glass 10 in accordance with an embodiment of the present disclosure is shown. The LED glass 10 includes a base 20, a plurality of LEDs 40 mounted on the base 20, a cover 30, an interlayer 50 sandwiched between the base 20 and the cover 30 and a bracket 60 fixing the base 20 and the cover 30 together.

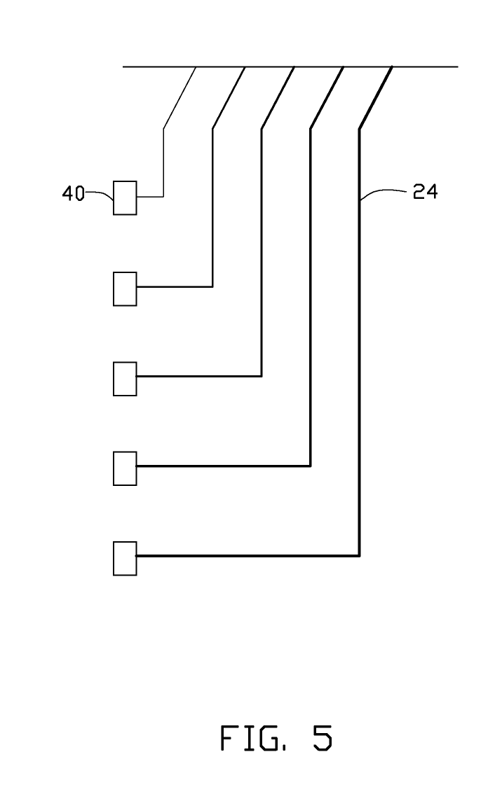

Also referring to FIG. 5, the base 20 may be made of transparent glass material. The base 20 may have a rectangular shape with two through holes 22 defined in two adjacent corners thereof. Electrical routes 24 may be formed on an inner face of the base 20 facing the cover 30. The electrical routes 24 may be made of silver paste, ITO (Indium Tin Oxide) or other conductive materials, wherein silver paste is preferable in this embodiment due to high electrical-conductive capability thereof. Alternatively, ITO may also be used in the present disclosure due to transparent appearance thereof. The LEDs 40 are mounted on and electrically connected to the electrical routes 24. The LEDs 40 may be activated to emit visible light. A flexible printed circuit film 80 is connected to the electrical routes 24 via an ACF (anisotropic conductive film) to introduce power to the LEDs 40 and located approximately at a periphery of the base 20. The flexible printed circuit film 80 may be very thin and attached on the inner face of the base 20.

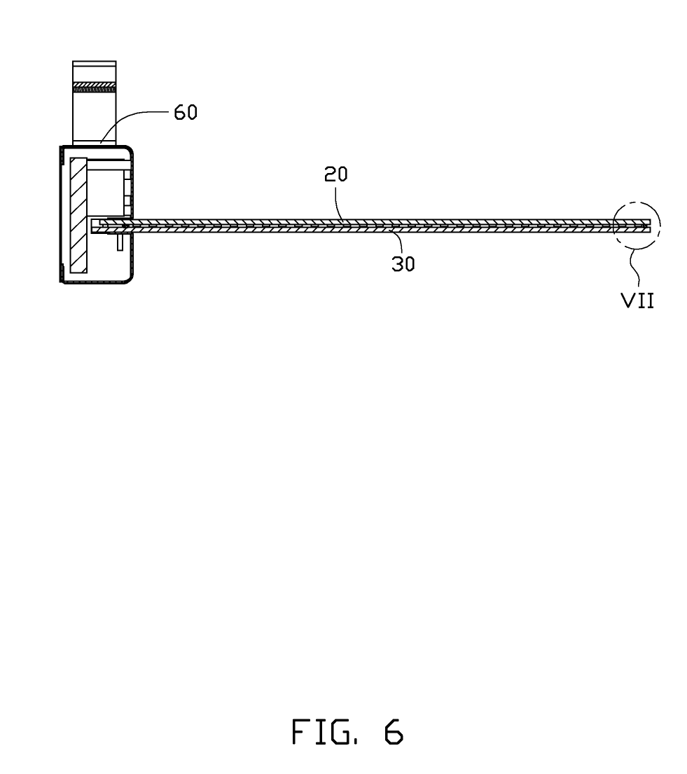

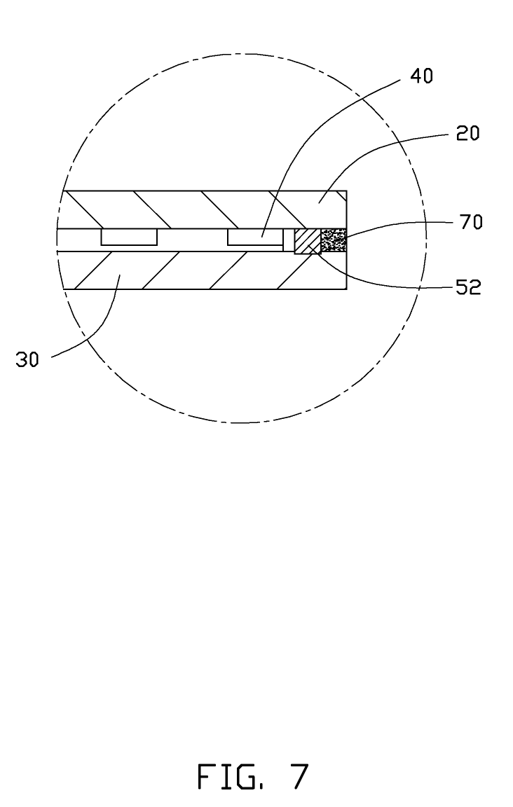

Also referring to FIGS. 6-7, the interlayer 50 may be made of transparent and rigid materials such as PC (polycarbonate) or PMMA (polymethylmethacrylate). The interlayer 50 can retain its rigidity even subject to a temperature about 150-200 degrees Celsius. The interlayer 50 includes a hollow frame 52 defining a large opening 520 therein. The frame 52 is rectangular and has a size slightly less than that of the base 20. The frame 52 is disposed on the inner face of the base 20. The flexible printed circuit film 80 is sandwiched between the frame 52 and the base 20. The LEDs 40 are received within the opening 520 and surrounded by the frame 52. Four lateral faces of the outer periphery of the frame 52 are spaced distances from corresponding lateral sides of the base 20, wherein the lateral face of the outer periphery of the frame 52 connected to the bracket 60 is spaced 50 mm from a corresponding lateral side of the base 20, and the other three adjacent lateral faces of the outer periphery of the frame 52 each are spaced 5 mm from a corresponding lateral side of the base 20 (see FIG. 7). A pair of ears 54 are formed on two neighboring corners of the frame 52. Each ear 54 has a through hole 540 defined therein and aligned with a corresponding through hole 22 of the base 22.

The cover 30 may also be made of transparent glass material. The cover 30 has a shape and a size equal to that of the base 20. The cover 30 also defines two through holes 32 in two adjacent corners thereof corresponding to the two through holes 22 of the base 20. When the cover 30 is disposed on the interlayer 50 to sandwich the interlayer 50 between the cover 30 and the base 20, a groove is defined between inner faces of the cover 30 and the base 20 at an outer side of each lateral face of the outer periphery of the frame 52. Three adjacent grooves each have a width of 5 mm, and a remaining groove located in the bracket 60 has a width of 50 mm. An adhesive material 70 is filled into each groove to glue the corresponding lateral face of the outer periphery of the frame 52 and the inner faces of the cover 30 and the base 20 together. The adhesive material 70 may be made of silicon glue or UV (ultraviolet) curing glue. The adhesive material 70 is also transparent so that it is invisible from an outside of the LED glass 10. The three adjacent grooves each having a width of 5 mm are substantially completely filled with the adhesive material 70, and the remaining groove having a width of 50 mm is partially filled with the adhesive material 70 wherein the adhesive material 70 has a width about 5 mm only. Therefore, the cover 30, the base 20 and the interlayer 50 are fixed together by the adhesive material 70.

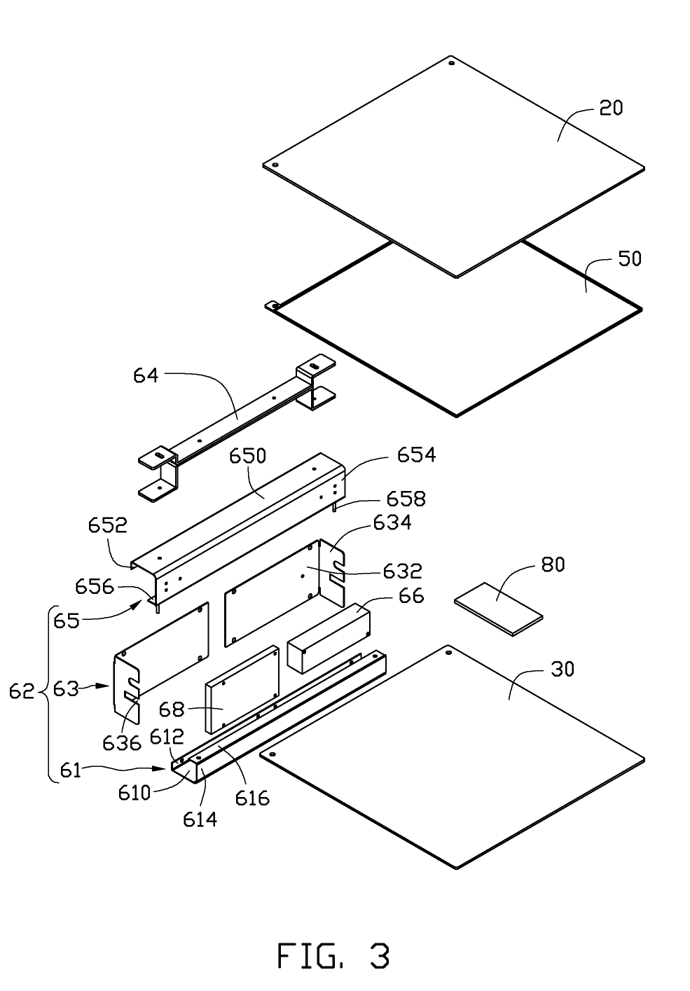

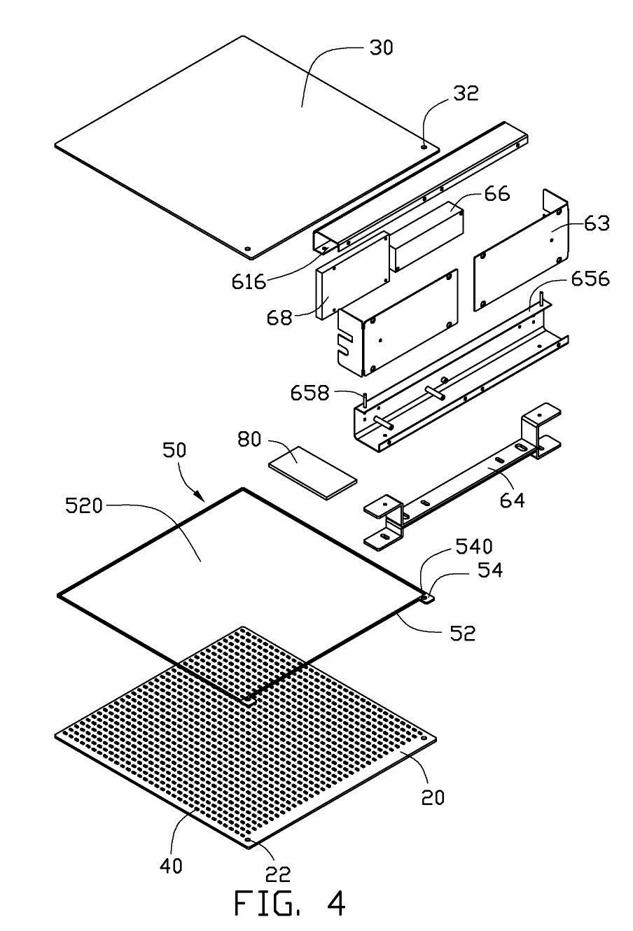

Referring to FIGS. 3-4 again, the bracket 60 includes a housing 62, an arm 64 fixed on the housing 62, a driving module 66 and a controlling module 68 received in the housing 62. The housing 62 includes a first fixing member 61, a second fixing member 65 and two lateral fixing members 63 fixed to the first fixing member 61 and the second fixing member 65. The first fixing member 61 and the second fixing member 65 are oriented towards two opposite directions (i.e., toward each other). Each of the first fixing member 61 and the second fixing member 65 includes a large horizontal plate 610, 650, a long vertical plate 614, 654 extending from a lateral side of the horizontal plate 640, 650 toward each other, a short vertical flange 612, 652 extending from an opposite lateral side of the horizontal plate 610, 650 toward each other and a small horizontal flange 616, 656 extending from a free end of the vertical plate 614, 654. The vertical flanges 612, 652 are parallel to the vertical plates 614, 654, and perpendicular to the horizontal flanges 616, 656 and the horizontal plates 610, 650. The second fixing member 65 further has two poles 658 extending from the horizontal flange 656 towards the first fixing member 61. The horizontal flange 656 of the second fixing member 65 abuts against an outer face of the base 20, and the horizontal flange 616 of the first fixing member 61 abuts against an outer face of the cover 30, thereby pressing the cover 30, the base 20 and the interlayer 50 between the first fixing member 61 and the second fixing member 65. The two poles 658 of the second fixing member 65 extend through the through holes 22, 540, 32 of the base 20, the interlayer 50 and the cover 30 in turn. The two lateral fixing members 63 each include a wall 632 and a baffle plate 634 extending from a lateral side of the wall 632. The wall 632 is parallel to the vertical plates 614, 654, and the baffle plate 634 is perpendicular to the wall 632 and the horizontal plates 610, 650. A slot 636 is defined in the baffle plate 634 of each lateral fixing member 63 corresponding to a level of the cover 30 and the base 20. The vertical flanges 612, 652 of the first fixing member 61 and the second fixing member 65 are fixed to the walls 632 of the two lateral fixing members 63, thereby forming the housing 62.

The controlling module 68 is electrically connected to the flexible printed circuit film 80, and the driving module 66 is electrically connected to the controlling module 68. The controlling module 68 may control light emitted from the LEDs 40 to thereby form required light patterns. In this embodiment, the controlling module 68 may be a GPRS (general packet radio service) card which can receive wireless signals from an outside environment. The driving module 66 provides power to the LEDs 40 to drive the LEDs 40 to lighten.

Since the interlayer 50 is fixed to the cover 30 and the base 20 at the outer periphery thereof, no variation of refractive index caused by the interlayer 50 occurs on light pathways of the LEDs 40. Therefore, the light emitted from the LEDs 40 received in the opening 520 of the interlayer 50 is not affected by the interlayer 50. Beams of the light from the LEDs 40 can retain their original directions, without generating halos.

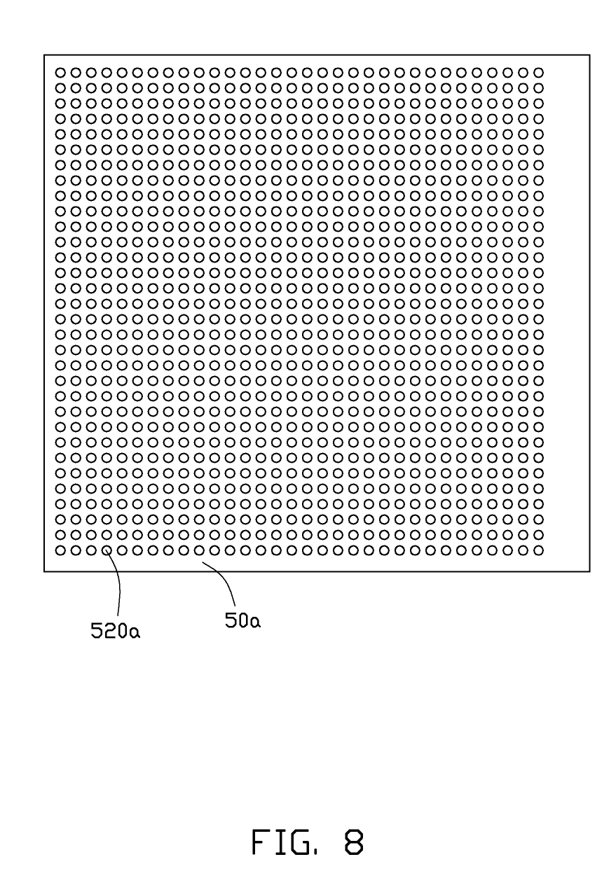

Alternatively, as shown in FIG. 8, the interlayer may also be a transparent plate 50a which has a plurality of openings 520a defined therein. Each opening 520a corresponds an LED 40 to receive the LED 40 therein. The openings 520a are arranged in matrix and extend from a top face to a bottom face of the transparent plate 50a. The transparent plate 50a may also be made of materials similar to the frame 52. An outer periphery of transparent plate 50a has a size the same as that of the frame 50. The transparent plate 50 is fixed to the cover 30 and the base 20 by gluing the outer periphery of the transparent plate 50 and the cover 30 and the base 20 with the adhesive material 70. The light emitted from the LEDs 40 passes through the openings 520a and the cover 30 to the outside environment.

Furthermore, the frame 50 and the transparent plate 50a may also be made of soft materials such as PVB (polyvinyl butyral). The PVB may melt under a temperature range between 100 and 300 degrees and become adhesive. Therefore, the interlayer 50a can fix the cover 30 and the base 20 together by itself under a melting temperature, without use of the adhesive material 70. The light emitted by the LEDs 40 can still pass through the opening 520 or the openings 520a without being affected by the interlayer 50.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED (light emitting diode) glass comprising:
a transparent base having electrical routes formed thereon;
a transparent cover spaced from the base;
an LED disposed between the base and the cover and electrically connected to the electrical routes;
an interlayer disposed on the base, the interlayer defining an opening to receive the LED therein;
wherein the interlayer is fixed between the base and the cover at a position outside light pathway of the LED, whereby the interlayer is inactive to light generated by the LED.

2. The LED glass of claim 1, wherein the light emitted from the LED radiates through the opening and the cover to an outside environment, and the light emitted from the LED is not refracted by the interlayer before radiating out from the cover.

3. The LED glass of claim 2, wherein the opening extends through two opposite faces of the interlayer.

4. The LED glass of claim 1, wherein the interlayer is fixed to the base and the cover at positions adjacent to an outer periphery of the interlayer.

5. The LED glass of claim 5, wherein a groove is formed between the outer periphery of the interlayer and two opposite faces of the base and the cover, and an adhesive material is filled into the groove to glue the interlayer, the base and the cover together.

6. The LED glass of claim 1, wherein the interlayer is made of a rigid and transparent material.

7. The LED glass of claim 1, wherein the interlayer is made of a soft and transparent material which melts and becomes adhesive under temperature ranging between 100 degrees and 300 degrees Celsius.

8. The LED glass of claim 4, wherein the interlayer comprises a hollow frame, the opening being defined adjacent to the outer periphery of the frame.

9. The LED glass of claim 4, wherein the interlayer comprises a transparent plate defining a plurality of openings, the LED being received in one of the openings.

10. The LED glass of claim 1 further comprising a bracket fixing the base with the cover, wherein the bracket comprises a housing having two parallel plates abutting the base and the cover, respectively.

11. The LED glass of claim 10, wherein the bracket has a driving module and a controlling module received in the housing, the LED being electrically connected to the driving module and the controlling module.

12. A method for manufacturing an LED (light emitting diode) glass comprising:
providing a transparent base having an LED mounted thereon;
disposing an interlayer on the base, the interlayer having an opening receiving the LED therein;
disposing a transparent cover on the interlayer, an outer periphery of the interlayer and inner faces of the cover and the base defining a groove around the interlayer;
filling an adhesive material in the groove to fix the interlayer with the base and the cover.

13. The method of claim 12 further comprising a step of placing a flexible circuit film on the base before disposing the interlayer on the base, wherein the flexible film is electrically connected to the LED.

14. The method of claim 13 further comprising a step of mounting a bracket to the base and the cover, wherein the bracket comprises a housing having two parallel plates sandwiching the cover, the interlayer and the base therebetween.

15. The method of claim 14, wherein the bracket having a driving module and a controlling module received in the housing, the flexible circuit film being electrically connected to the driving module and the controlling module.

16. The method of claim 15, wherein the controlling module is a GPRS (general packet radio service) card which receives wireless signals from an outside environment.

17. The method of claim 12, wherein the interlayer is made of a transparent and rigid material.

18. The method of claim 12, wherein the opening is adjacent to the outer periphery of the interlayer.
